(19) United States
(12) Patent Application Publication
(10) Pub. No.: US 2020/0134714 A1
(43) Pub. Date: Apr. 30, 2020

(54) SYSTEMS AND METHODS FOR DIGITAL VERIFICATION OF CUSTOMER INFORMATION

(71) Applicant: JPMorgan Chase Bank, N.A., New York, NY (US)

(72) Inventors: Jasmine De Gaia, Lewis Center, OH (US); Anahit Mikayelyan Cooper, New Albany, OH (US); Mark Tamas Seres, St. Augustine, FL (US); Colin McCormick, Paradise Valley, AZ (US); William Addison Peri, Mahwah, NJ (US)

(21) Appl. No.: 16/172,183

(22) Filed: Oct. 26, 2018

(51) Int. Cl. G06Q 40/02; G06F 17/30

(52) U.S. Cl. CPC G06Q 40/025; G06F 17/30988

(57) ABSTRACT

Systems and methods for digital verification of customer information are disclosed. In one embodiment, in an information processing apparatus comprising at least one computer processor, a method for digital verification of customer information may include: (1) receiving, from a customer, an application for a financial product offered by a financial institution; (2) automatically retrieving, from at least one database, direct deposit activity for the customer for a predetermined period of time; (3) determining a customer income based on the direct deposit activity; (4) determining a confidence in the customer income; and (5) in response to the confidence being above a threshold, approving the customer for the financial product based on the determined customer income.

### BACKGROUND OF THE INVENTION

### 1. Field of the Invention

The present disclosure generally relates to systems and methods for digital verification of customer information.

### 2. Description of the Related Art

As part of applying for a financial product with a financial institution, customers are often required to provide information regarding their income, assets, and employment history. This process generally involves the receipt and processing of paper documentation, which is cumbersome to customers, time consuming, and there is a risk of fraud or manipulation of the paper documents.

### SUMMARY OF THE INVENTION

Systems and methods for digital verification of customer information are disclosed. In one embodiment, in an information processing apparatus comprising at least one computer processor, a method for digital verification of customer information may include: (1) receiving, from a customer, an application for a financial product offered by a financial institution; (2) automatically retrieving, from at least one database, direct deposit activity for the customer for a predetermined period of time; (3) determining a customer income based on the direct deposit activity; (4) determining a confidence in the customer income; and (5) in response to the confidence being above a threshold, approving the customer for the financial product based on the determined customer income.

In one embodiment, the confidence in the customer income may be based on a regularity of the direct deposit activity and a consistency of an amount of the direct deposit activity.

In one embodiment, the confidence in the customer income may be based on a number of direct deposits in the direct deposit history in the predetermined time.

In one embodiment, the confidence in the customer income may be based a consistency in an source of the direct deposit activity.

In one embodiment, the method may further include identifying at least one reason for the confidence in the customer income being below the threshold; and determining that the reason for the confidence in the customer income being below the threshold is sufficient to increase the confidence in the customer income above the threshold.

In another embodiment, in an information processing apparatus comprising at least one computer processor, a method for digital verification of customer information may include: (1) receiving, from a customer, an application for a financial product offered by a financial institution; (2) receiving, from the customer, an identification of a plurality of income sources; (3) automatically retrieving, from at least one database, direct deposit activity for the customer for a predetermined period of time; (4) determining a customer income based on the direct deposit activity; (5) determining a confidence in the customer income; (7) in response to the confidence being below a threshold, recalculating the customer income based on non-salary sources of income; and (8) approving the customer for the financial product based on the recalculated customer income.

In one embodiment, the confidence in the customer income may be based on a regularity of the direct deposit activity and a consistency of an amount of the direct deposit activity.

In one embodiment, the confidence in the customer income may be based on a number of direct deposits in the direct deposit history in the predetermined time.

In one embodiment, the confidence in the customer income may be based a consistency in an source of the direct deposit activity.

In one embodiment, the method may further include identifying at least one reason for the confidence in the customer income being below the threshold; and determining that the reason for the confidence in the customer income being below the threshold is sufficient to increase the confidence in the customer income above the threshold.

In one embodiment, the identification of the plurality of income sources may be received in a questionnaire that may be presented on a mobile electronic device, a kiosk, an ATM, or an Internet of Things appliance.

In one embodiment, the non-salary deposit sources of income comprise one of Social Security income and salary income.

In one embodiment, the method may further include requesting income verification from a third party.

In another embodiment, in an information processing apparatus comprising at least one computer processor, a method for automatically refreshing at least one parameter for a financial product may include: (1) receiving a plurality of parameters for a financial product issued to a customer and a customer income for a first period of time on which the financial product was approved; (2) updating the customer income for the customer based on direct deposit activity for the customer during a second period of time; and (3) adjusting a term associated with the financial product based on the updated customer income.

In one embodiment, the term may be a lend rate, an interest rate, etc.

In one embodiment, the method may further include determining a confidence in the updated customer income.

In one embodiment, the confidence in the updated customer income may be based on a regularity of the direct deposit activity and a consistency of an amount of the direct deposit activity in the second period of time.

In one embodiment, the confidence in the updated customer income may be based on a number of direct deposits in the direct deposit history in the second period of time.

In one embodiment, the confidence in the updated customer income may be based a consistency in an source of the direct deposit activity in the second period of time.

In one embodiment, in an information processing apparatus comprising at least one computer processor, a method for digital verification of customer information may include: (1) receiving, from a customer, an application for a financial product offered by a financial institution, the application comprising a stated income amount and a stated asset amount; (2) automatically retrieving, from at least one database, account balances for customer accounts and deposit activity for the customer for a predetermined period of time; (3) digitally verifying the stated income based on direct deposits during the predetermined period of time; and (4) digitally verifying the stated assets based on the account balances during the predetermined period of time. The digital verification does not involve paper documentation of income, assets, or employer.

In one embodiment, the method may further include receiving approval from the customer to digitally verify the stated income amount and the stated asset amount.

In one embodiment, the application for the financial product may also include a stated employer, and the method may further include digitally verifying the stated employer based on the direct deposits during the predetermined period of time. The method may also include receiving approval from the customer to digitally verify the stated employer.

In one embodiment, the method may further include retrieving, from the least one database, updated account balances for customer accounts and updated deposit activity for the customer for a second predetermined period of time; updating a customer income for the customer based on direct deposits during the second predetermined period of time; and adjusting a term associated with the financial product based on the updated customer income. The term may be a lend rate, an interest rate, etc.

In one embodiment, the method may further include providing a third party with the stated income; and receiving third party verification of the state income. The stated income may be provided to the third party using an application programmable interface. The third party verification of the state income may include a score.

According to another embodiment, a system for digital verification of customer information may include a financial institution computer processor executing a digital verification computer program, and at least one database. The digital verification computer program may receive, from a customer, an application for a financial product offered by a financial institution, the application comprising a stated income amount and a stated asset amount; automatically retrieve, from the at least one database, account balances for customer accounts and deposit activity for the customer for a predetermined period of time; digitally verify the stated income based on direct deposits during the predetermined period of time; and digitally verify the stated assets based on the account balances during the predetermined period of time. The digital verification does not involve paper documentation of income, assets, or employer.

In one embodiment, the digital verification computer program may receive approval from the customer to digitally verify the stated income amount and the stated asset amount.

In one embodiment, the application for the financial product further may include a stated employer, and the digital verification computer program may further digitally verify the stated employer based on the direct deposits during the predetermined period of time. The digital verification computer program may receive approval from the customer to digitally verify the stated employer.

In one embodiment, the digital verification computer program may further retrieve, from the least one database, updated account balances for customer accounts and updated deposit activity for the customer for a second predetermined period of time; update the customer income for the customer based on direct deposits during the second predetermined period of time; and adjust a term associated with the financial product based on the updated customer income. The term may be a lend rate, an interest rate, etc.

In one embodiment the digital verification computer program may further provide a third party with the stated income, and receive third party verification of the state income. The stated income may be provided to the third party using an application programmable interface. The third party verification of the state income may include a score.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for digital verification of customer information according to one embodiment;

FIG. 2 depicts a method for digital verification of customer information according to one embodiment; and

FIG. 3 depicts a method for digital verification of customer information according to another embodiment.

### DETAILED DESCRIPTION OF PREFERRED EMBODIMENTS

Embodiments disclosed herein relate to a system and method for digital verification of customer information, such as income, assets, and employment.

Embodiments may provide some or all of the following advantages: (1) digital verification of income, assets, and/or employment may be performed quickly (e.g., in a matter of seconds); (2) digital verification may eliminate unnecessary back and forth with customers; (3) digital verification may eliminate the need for income documentation, such as paystubs or W-2s, asset documentation, or employment documentation; and (4) digital verification may reduce the chance of data breach or fraud due to the decrease in document sharing. Other advantages exist.

Although this disclosure may be made in the context of a mortgage, it should be recognized that it has applicability with other financial products as well.

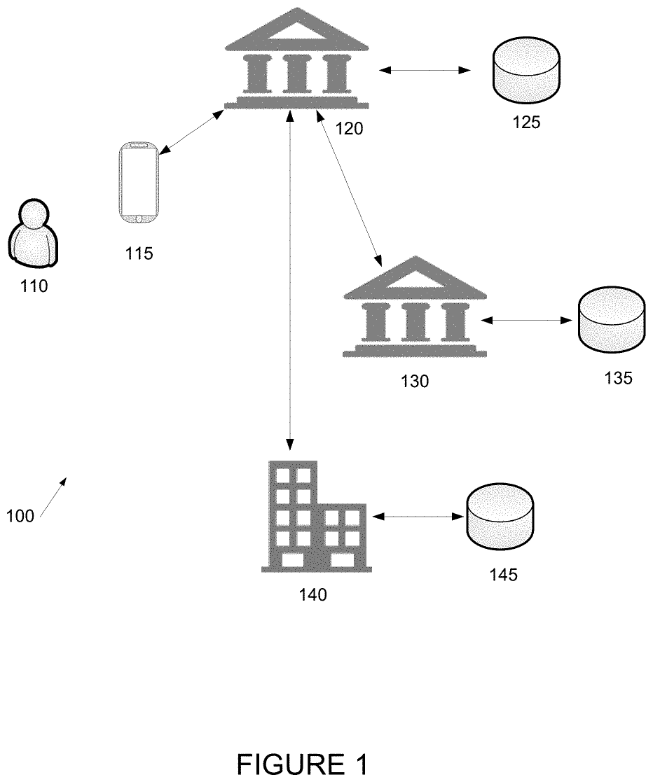

Referring to FIG. 1, a system for digital verification of customer information is disclosed according to one embodiment. System 100 may include customer 110 that may be current or potential customer of financial institution 120. Customer 110 may interact with financial institution 120 using, for example, electronic device 115. Electronic device 115 may be associated with customer 110 (e.g., a tablet computer, desktop/laptop computer, smartphone, Internet of Things appliance, etc.), or it may be associated with financial institution 120 (e.g., a branch tablet computer or desktop/laptop computer, a kiosk, an ATM, etc.). Financial institution 120 may be associated with internal database 125 that may store customer records for customers of the financial institution (e.g., account information, transaction information, etc.).

Financial institution 120 may host one or more computer processors that may execute a computer program or application (not shown) that may digitally verify, for example, the customer's customer information. Financial institution 120 may interact with internal database 125, and third parties 130 and 140 to request and receive external customer data. For example, third party 130 or 140 may include a credit agency, Government-Sponsored Entities (“GSEs”), such as Federal National Mortgage Association (FNMA or “Fannie Mae”), Federal Home Loan Mortgage Corporation (FHLMC of “Freddie Mac”), etc.), private label security investors, other financial institutions, etc.

Each third party 130, 140 may be associated with a respective database and/or backend (e.g., 135, 145) that may hold customer data. In one embodiment, in response to a request from financial institution 120, third party 130, 140 may provide raw customer data, a score, a derived income net to gross, or other customer assessment as is necessary and/or desired.

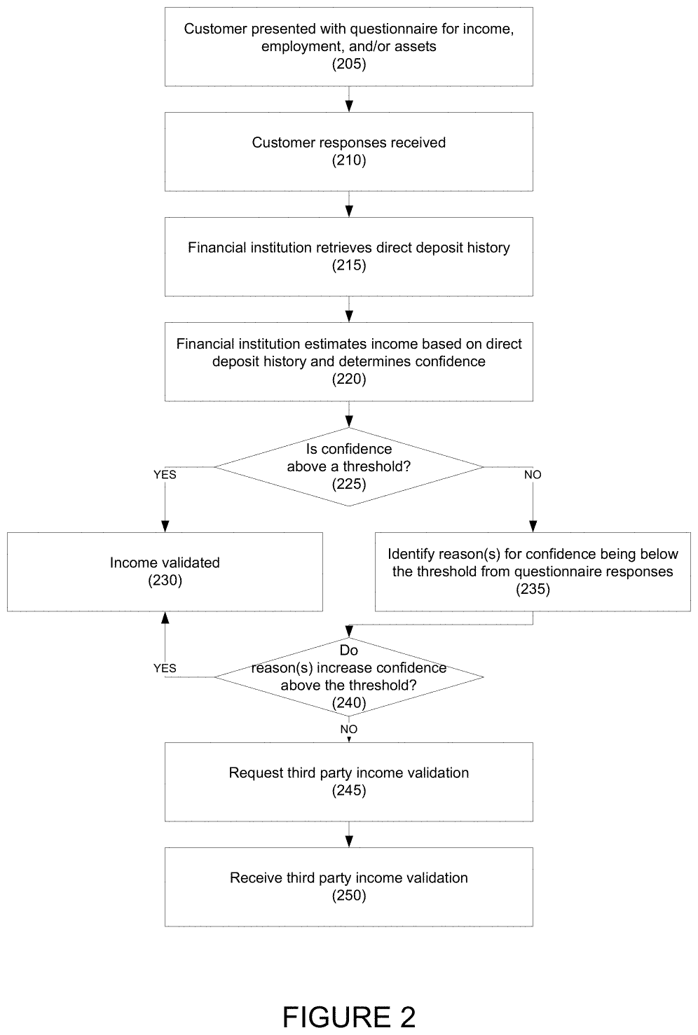

Referring to FIG. 2, a method for digital verification of customer information is disclosed according to one embodiment. In step 205, a customer, who may be either a current customer or a prospective customer, of a financial institution may apply for a bank product (e.g., a loan, an account, a financial instrument, etc.), and, as part of the process, may be presented with a questionnaire regarding the customer's income, employment, and/or assets.

For example, the customer may be asked about different sources of income and may provide income amounts. The customer may be asked if they have a salaried income, overtime income, social security income, etc.

In one embodiment, the questionnaire may be presented on the customer's mobile electronic device, on a website, at a kiosk, at an ATM, at an Internet of Things (IoT) device, etc.

In one embodiment, as part of the questionnaire, the customer may authorize retrieval of the customer's digital information.

In step 210, the customer may provide responses to the questionnaire. For example, the customer may identify internal and/or external party data sources (e.g., financial institution names, brokerages, employers, etc.) and may provide identifying information (e.g., account numbers) for the accounts with those third parties.

In one embodiment, the responses may be entered manually into an application or computer program, may be received audibly, etc.

In one embodiment, the received income may be classified based on income type. For example, Social Security income and overtime income from a salaried source may be classified differently. For example, the financial institution may not know that direct deposit income is overtime income from the direct deposit data. Instead, based on the customer's responses, the income may be reallocated to the appropriate category.

In step 215, the financial institution may retrieve the customer's direct deposit history, and, in step 220, may estimate the customer's income based on the direct deposit history. In one embodiment, the financial institution may determine a confidence in the customer's income based, for example, on the regularity of the deposits (e.g., both amount and periodicity of the deposits), the source of the deposits, etc.

For example, the financial institution may have a greater income confidence for customer that receives a direct deposit of substantially the same amount every two weeks than for a customer that receives a different direct deposit amount every two weeks or that receives a direct deposit at irregular intervals.

In step 225, if the confidence is above a threshold (e.g., the deposit amount and/or the regularity of the deposits varies by less than a predetermined amount), in step 230, the customer's income may be validated and the customer may be approved for the financial product.

In one embodiment, the level of confidence may depend on the bank product being applied for (e.g., the value of the product), the risk associated with the customer, etc.

If the confidence is not above the threshold, the financial institution may identify one or more reasons for the confidence being below the threshold (e.g., the customer is paid on commission, the customer does not have enough deposits to give confidence in the direct deposit history, the customer recently changed jobs, the customer has income from different sources, etc.). If, in step 240, the reason(s) are sufficient to increase the confidence above the threshold, or to explain why the confidence is not above the threshold (e.g., income varies significantly but the average is sufficient for the financial product), the income may be validated in step 230.

In one embodiment, the financial institution may consider other sources of income (e.g., social security, alimony, etc.) to increase the confidence level.

If the reason(s) are not sufficient, in step 245, income validation may be requested from a third party (e.g., a GSE). In step 250, the financial institution may receive income validation from the third party.

In one embodiment, the financial institution may provide the third party with the customer's stated gross income, income type, self-employment indicator, employer name, residence state, marital status, and any other information as is necessary and/or desired.

In one embodiment, the verification may be from a GSE.

In one embodiment, the request may be made using an application programmable interface, or API. The API may provide a direct bridge to share customer transaction history with the third party source.

In step 245, the third party may respond to the request, and may provide, for example, raw customer data, a score, or other customer assessment as is necessary and/or desired.

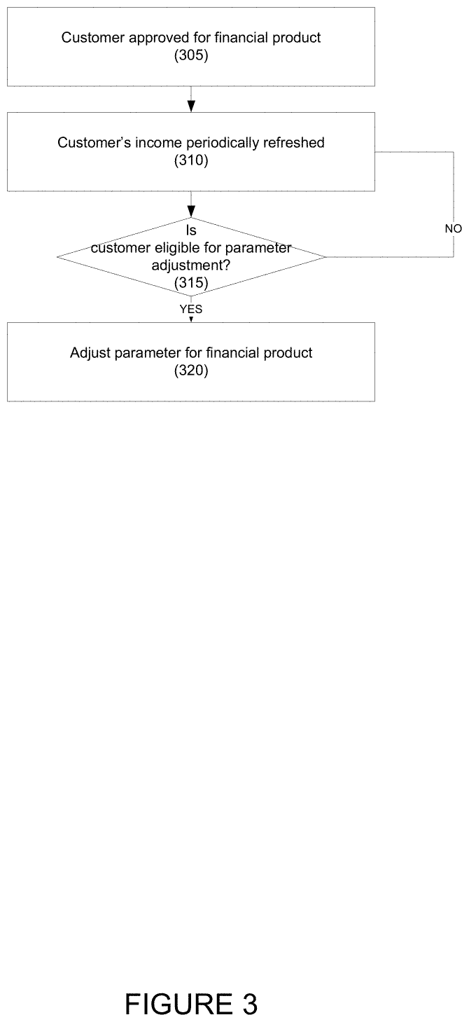

Referring to FIG. 3, a method of periodic financial product refresh is disclosed according to on embodiment.

In step 305, a customer may be approved for a financial product based on the verification of the customer's income. The customer may optionally authorize the customer's income to be periodically refreshed for potential adjustment of a term for the financial product or to provide a benefit to the customer. For example, if the customer's income change favorably, the financial institution may lock in a new adjustable rate, extend the term, offer cash out to the customer, etc. Any other suitable adjustments and/or benefits may be made or provided as is necessary and/or desired.

In step 310, the customer's income may be periodically refreshed. In one embodiment, this may include reviewing the customer's direct deposit history, determining the customer's income, and determining a confidence in the customer's income. This may be similar to step 220, above.

In step 315, if a periodic income refresh indicates a favorable change in income, in step 320, the financial institution may automatically adjust one or more term for the financial product or provide a benefit to the customer. For example, if the customer's income increases, the customer's rate on a mortgage may automatically be reduced without the need for refinancing, etc. The rate decrease may be based on the increase in income, or it may be based on a general decrease in rates.

If, in step 315, the customer is not eligible for the an adjustment, the process may repeat in the next period.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for digital verification of customer information, comprising:
in an information processing apparatus comprising at least one computer processor:
receiving, from a customer, an application for a financial product offered by a financial institution;
automatically retrieving, from at least one database, direct deposit activity for the customer for a predetermined period of time;
determining a customer income based on the direct deposit activity;
determining a confidence in the customer income; and
in response to the confidence being above a threshold, approving the customer for the financial product based on the determined customer income.

2. The method of claim 1, wherein the confidence in the customer income is based on a regularity of the direct deposit activity and a consistency of an amount of the direct deposit activity.

3. The method of claim 1, wherein the confidence in the customer income is based on a number of direct deposits in the direct deposit history in the predetermined time.

4. The method of claim 1, wherein the confidence in the customer income is based a consistency in an source of the direct deposit activity.

5. The method of claim 1, further comprising:
identifying at least one reason for the confidence in the customer income being below the threshold; and
determining that the reason for the confidence in the customer income being below the threshold is sufficient to increase the confidence in the customer income above the threshold.

6. A method for digital verification of customer information, comprising:
in an information processing apparatus comprising at least one computer processor:
receiving, from a customer, an application for a financial product offered by a financial institution;
receiving, from the customer, an identification of a plurality of income sources;
automatically retrieving, from at least one database, direct deposit activity for the customer for a predetermined period of time;
determining a customer income based on the direct deposit activity;
determining a confidence in the customer income;
in response to the confidence being below a threshold, recalculating the customer income based on non-salary sources of income; and
approving the customer for the financial product based on the recalculated customer income.

7. The method of claim 6, wherein the confidence in the customer income is based on a regularity of the direct deposit activity and a consistency of an amount of the direct deposit activity.

8. The method of claim 6, wherein the confidence in the customer income is based on a number of direct deposits in the direct deposit history in the predetermined time.

9. The method of claim 6, wherein the confidence in the customer income is based a consistency in an source of the direct deposit activity.

10. The method of claim 6, further comprising:
identifying at least one reason for the confidence in the customer income being below the threshold; and
determining that the reason for the confidence in the customer income being below the threshold is sufficient to increase the confidence in the customer income above the threshold.

11. The method of claim 6, wherein the identification of the plurality of income sources is received in a questionnaire presented on a mobile electronic device, a kiosk, an ATM, or an Internet of Things appliance.

12. The method of claim 6, wherein the non-salary deposit sources of income comprise one of Social Security income and salary income.

13. The method of claim 6, further comprising:
requesting income verification from a third party.

14. A method for automatically refreshing at least one parameter for a financial product, comprising:
in an information processing apparatus comprising at least one computer processor:
receiving a plurality of parameters for a financial product issued to a customer and a customer income for a first period of time on which the financial product was approved;
updating the customer income for the customer based on direct deposit activity for the customer during a second period of time; and
adjusting a term associated with the financial product based on the updated customer income.

15. The method of claim 14, wherein the term is a lend rate.

16. The method of claim 14, wherein the term is an interest rate.

17. The method of claim 14, further comprising:
determining a confidence in the updated customer income.

18. The method of claim 17, wherein the confidence in the updated customer income is based on a regularity of the direct deposit activity and a consistency of an amount of the direct deposit activity in the second period of time.

19. The method of claim 17, wherein the confidence in the updated customer income is based on a number of direct deposits in the direct deposit history in the second period of time.

20. The method of claim 17, wherein the confidence in the updated customer income is based a consistency in an source of the direct deposit activity in the second period of time.
